(19) United States
(12) Patent Application Publication
(10) Pub. No.: US 2026/0307281 A1
(43) Pub. Date: Oct. 8, 2026

(54) DEVICES AND METHODS FOR SMART PERSONAL GROOMING

(71) Applicant: The Procter & Gamble Company, Cincinnati, OH (US)

(72) Inventors: Aditya Milind DESHPANDE, Cincinnati, OH (US); Faiz Feisal SHERMAN, Mason, OH (US)

(21) Appl. No.: 19/637,012

(22) Filed: Apr. 2, 2026

Related U.S. Application Data
(60) Provisional application No. 63/782,056, filed on Apr. 2, 2025.

(51) Int. Cl. B26B 19/38; B26B 19/46; G06V 10/74

(52) U.S. Cl. CPC B26B 19/388; B26B 19/46; G06V 10/761

(57) ABSTRACT

A smart personal grooming device or otherwise cutting device comprises a body with a handle, a head portion, a hair cutting implement, and a camera oriented toward the hair cutting implement. The camera captures images of a skin area and a hair area of a user and a processor detects, based a number of hair edge pixels in the image, each of the skin area and the hair area. A boundary is defined between the skin area and the hair area. The processor determines a control state based on the boundary that causes the processor to implement one or more algorithms controlling an operating or feature of the smart personal grooming device or otherwise cutting device, including, for example, activating the cutting implement to cause the cutting implement to remove hair in a hair area of the user.

### FIELD

The present disclosure generally relates to grooming devices and methods, and more particularly to, devices and methods for smart personal grooming.

### BACKGROUND

Users typically experience difficulty guiding or handling shaving devices in precise manners to trim or otherwise cut their own hair. This problem can be particularly acute for areas difficult to reach or see, such as the user’s face or otherwise an area that requires the user to shave by use of a mirror or other indirect vision. For these reasons, precise shaving or hair removal requires manual assistance of another person. For example, an individual with facial hair can visit a barber for assistance with cutting or trimming hair. After a few days, however, the facial hair begins to regrow (e.g., have hair stubble), and the user cannot readily maintain a style or cut himself or herself as previously provided by a barber.

Conventional trimming devices do not assist users, who have facial hair (or other difficult to address hair areas), to trim or cut such hair. An individual typically requires ad hoc tools like beard stencils over the face while shaving to maintain facial hair styles by themselves, which typically results in imprecise styles or cuts, or can also result in damage to user’s skin from lacerations caused by a blade or trimmer, pulled hair, or other skin damage provided by manual attempts at precise cutting or trimming.

In addition, previously known methods for hair style maintenance rely on shaping tools or chemical markers (e.g., dyes) for defining the hair style edges in addition to manual cutting using a manual instrument for cutting the hair and/or stubble. However, the use of these manual tools and/or chemicals makes the process of self-style maintenance difficult.

For the foregoing reasons, there is a need for devices and methods for smart personal grooming.

### SUMMARY

In various aspects herein, smart personal grooming devices and methods are described to address imprecise trimming or cutting, and/or to otherwise enhance user shaving. Such precision is achieved through image acquisition and image analysis captured while the user is shaving with a smart personal grooming or cutting device. Such a smart shaving device, also referred to herein as an “AutoEdger device,” can determine how or when to cut or trim hair based on image acquisition and analysis. The AutoEdger device provides a digital and image-based solution to enhance hair cutting and trimming, with the increased safety of using such a device having a sharp blade. The AutoEdger device also provides a standalone solution that can perform precise trimming and/or cutting itself by using a sensor to control a trimmer or blade.

Generally, the AutoEdger device comprises a hair trimmer or cutter with a sensor, e.g., an inbuilt optical sensor or otherwise a camera. The AutoEdger device comprises a sense-and-respond type of device for seamlessly and quickly maintaining precise hairstyles. Users with a hairstyle (e.g., a facial hairstyle) typically visit barbers for their styling. Their hair starts to regrow after the styling, and the crisp edges between the skin and the hair start to disappear after two or three days from the styling. Assuming that the average hair growth rate is approximately 0.3 mm per day, the AutoEdger device allows a user, himself or herself, to maintain precise or crisp edges between the skin and hair for an extended amount of time. The AutoEdger can detect and cut hair stubble, and can be configured to cut at a certain threshold height, such that the AutoEdger device may cut only the regrown hair (stubble). Therefore, users with a certain hairstyle (e.g., a certain beard style) can use the AutoEdger device to maintain their styles for an extended amount of time.

In some aspects, the techniques described herein relate to a smart personal grooming device including: a body including a handle; a head portion connected to the body and a hair cutting implement; a camera oriented toward the hair cutting implement and configured to capture images of a skin area and a hair area of a user when operating the smart personal grooming device; a processor communicatively coupled to the camera; a memory communicatively coupled to the processor and storing computing instructions that, when executed by the processor, causes the processor to: capture, by the camera, one or more images depicting the skin area of the user and the hair area of the user, use the one or more images to pixelate hair edges, count a value of pixels in each of the one or more images, detect, based on the counted value of pixels, each of the skin area and the hair area, wherein a boundary is defined between the skin area and the hair area; and determine a control state based on the boundary as detected in the one or more images, wherein the control state causes the computing instructions to execute the processor to implement at least one of: (a) activate the hair cutting implement to cause the hair cutting implement to remove hair in the hair area of the user; (b) deactivate the hair cutting implement; (c) activate of a haptic vibrator of the smart personal grooming device; (d) activate an audio device of the smart personal grooming device; (e) initiate a visual indicator of the smart personal grooming device; or (f) changing a cutting speed of the hair cutting implement.

In additional aspects, the techniques described herein relate to a smart personal grooming device, where the memory communicatively coupled to the processor and storing computing instructions, that, when executed by the processor, further cause the processor to separate each of the one or more images into a plurality of patches, where the use of the one or more images to pixelate the hair edges comprises pixelating the hair edges in each of the plurality of patches; and where the count of the value of hair edge pixels comprises a count of the value of hair edge pixels in each of the plurality of patches.

In additional aspects, the techniques described herein relate to a smart personal grooming device, where the pixelation of the hair edges in each of the plurality of patches comprises pixelating the hair edges adjacent a transition between the hair area and the skin area such that the counted value of pixels indicate a value of pixels in each of the plurality of patches that encompass hair edges adjacent the transition between the hair area and the skin area.

In additional aspects, the techniques described herein relate to a smart personal grooming device, where the processor compares a value of counted pixels in each of the plurality of patches with a threshold pixel value to detect the boundary defined between the skin area and the hair area.

In additional aspects, the techniques described herein relate to a smart personal grooming device where a value of the counted pixels in each of the plurality of patches below the threshold pixel value represents a skin area and a value of the counted pixels in each of the plurality of patches above the threshold pixel value represents a hair area.

In additional aspects, the techniques described herein relate to a smart personal grooming device, where the value of the counted pixels is a number of skin pixels, where a value of the counted pixels in each of the plurality of patches above the threshold pixel value represents a skin area and a value of the counted pixels in each of the plurality of patches below the threshold pixel value represents a hair area.

In additional aspects, the techniques described herein relate to a smart personal grooming device, where the processor detects the boundary defined between the skin area and the hair area based on the value of the counted pixels in at least one of the plurality of patches being above the threshold pixel value.

In additional aspects, the techniques described herein relate to a smart personal grooming device, where the plurality of patches are generally parallel to a width of the hair cutting implement.

In additional aspects, the techniques described herein relate to a smart personal grooming device, where the plurality of patches each have a shape comprising one or more of a square, a rectangle, a triangle, a circle, an oval or any polygon.

In additional aspects, the techniques described herein relate to a smart personal grooming device, where the plurality of patches encompass a width of the hair cutting implement.

In some aspects, the techniques described herein relate to a smart personal grooming device, wherein the plurality of images for training the learning model include images having height of 10 to 1944 pixels and width of 10 to 2592 pixels.

In some aspects, the techniques described herein relate to a smart personal grooming device, wherein each of the plurality of patches has an area that encompasses a total number of pixels and where the threshold pixel value is a ratio of the total number of pixels, where the ratio is greater than about 0.10 and less than about 0.50.

In some aspects, the techniques described herein relate to a smart personal grooming device, where the processor is configured to pixelate the hair edges in each of the plurality of patches based on one or more of adaptive enhancement, unsharp masking and adaptive edge extraction on each of the plurality of patches.

In some aspects, the techniques described herein relate to a contact sensor associated with the cutting implement such that the contact sensor is in contact with a skin area of a user, when operating the smart personal grooming device, and wherein the contact sensor is communicatively coupled with the processor.

In some aspects, the techniques described herein relate to a smart personal grooming device further including: subdividing into the plurality of patches each of the one or more images depicting the skin area of the user and the hair area of the user as captured by the camera, and assigning a patch-based classification to each patch of the plurality of patches based on comparing a value of the counted pixels in each of the plurality of patches with a threshold pixel value and where the control state is based on each patch-based classification.

In some aspects, the techniques described herein relate to a smart personal grooming device including an infrared light source oriented toward the hair cutting implement and configured to illuminate the skin area and hair area of a user when operating the smart personal grooming device.

In some aspects, the techniques described herein relate to a smart personal grooming device further including a second infrared light source oriented toward the hair cutting implement and configured to illuminate the skin area and hair area of a user when operating the smart personal grooming device.

In some aspects, the techniques described herein relate to a smart personal grooming device, wherein the hair cutting implement includes a rotary shaver.

In some aspects, the techniques described herein relate to a smart personal grooming device, wherein the hair cutting implement includes a foil and an undercutter.

In some aspects, the techniques described herein relate to a smart personal grooming device, wherein the hair cutting implement includes a reciprocating blade.

In some aspects, the techniques described herein relate to a smart personal grooming device, further comprising a contact sensor associated with the cutting implement such that the contact sensor is in contact with a skin area of a user, when operating the smart personal grooming device, and wherein the contact sensor is communicatively coupled with the processor and wherein the determination of the control state is further based on contact sensor data received from the contact sensor.

In some aspects, the techniques described herein relate to a smart personal grooming device, where the smart personal grooming device is deactivated until the contact sensor detects contact of the smart personal grooming device with the skin area or the hair area.

In some aspects, the techniques described herein relate to a smart personal grooming device, wherein the camera has a frame rate of at least 30 FPS.

In some aspects, the techniques described herein relate to a smart personal grooming device, where the camera has a frame rate between 10 to 500 FPS.

In some aspects, the techniques described herein relate to a smart personal grooming method including: capturing, by a camera, one or more images depicting a skin area of a user and a hair area of the user, wherein the camera is positioned relative to a body including a handle, wherein a head portion is connected to the body and a hair cutting implement, and wherein the camera is oriented toward the hair cutting implement and configured to capture images of the skin area and the hair area of the user when the user uses the hair cutting implement to cut or trim hair, separating, with a processor communicatively coupled with the camera, each of the one or more images into a plurality of patches, pixelating, with the processor, hair edges in each of the plurality of patches for each of the one or more images, counting, with the processor, a value of pixels in each of the plurality of patches in each of the one or more images, detecting by the processor, based on the counted value of pixels, each of the skin area and the hair area, wherein a boundary is defined between the skin area and the hair area; determining, by the processor, a control state based on the boundary as detected in the one or more images; and implementing, by the processor based on the control state, at least one of: (a) activating the hair cutting implement to cause the hair cutting implement to remove hair in the hair area of the user; (b) deactivating the hair cutting implement; (c) activating of a haptic vibrator; (d) activating an audio device; (e) initiating a visual indicator; or (f) changing a cutting speed of the hair cutting implement.

In addition, the present disclosure includes applying certain of the claim elements with, or by use of, a particular machine, e.g., a smart personal grooming device having a blade. The smart personal grooming device comprises a camera coupled to the shaving device configured to capture images of a skin area and a hair area of a user when operating the smart personal grooming device.

In addition, present disclosure includes improvements in computer functionality or in improvements to other technologies at least because the claims recite that, e.g., use of a camera as attached a smart personal grooming device configured to improve and enhance control or operation of the smart personal grooming device based on image input and analysis. That is, the present disclosure describes improvements in the functioning of the computer itself or “any other technology or technical field” because the control of the smart personal grooming device becomes more precise in its operation, e.g., to activate a hair cutting implement (e.g., a blade) to cause the hair cutting implement to remove hair in a hair area of the user. This improves over the prior art at least because conventional razors or otherwise cutting instruments lack such cutting precision or otherwise control.

In addition, the present disclosure includes specific features other than what is well-understood, routine, conventional activity in the field, or adds unconventional steps that confine the claim to a particular useful application, e.g., devices and methods for smart personal grooming as described herein.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example of a smart personal grooming device in accordance with various embodiments disclosed herein.

FIG. 2 illustrates an example front view of the smart personal grooming device of FIG. 1 as positioned with respect to a skin area and a hair area of a user in accordance with various embodiments disclosed herein.

FIG. 3A illustrates an example side view of the smart personal grooming device of FIG. 1 as positioned with respect to a skin area and a hair area of a user in accordance with various embodiments disclosed herein.

FIG. 3B illustrates an example perspective view of the smart personal grooming device of FIG. 1 as positioned with respect to a skin area and a hair area of a user in accordance with various embodiments disclosed herein.

FIG. 4A illustrates example images of respective hair areas of a user in accordance with various embodiments disclosed herein.

FIG. 4B illustrates example images of respective skin areas of a user in accordance with various embodiments disclosed herein.

FIG. 5A illustrates an image depicting a boundary defined between a skin area and a hair area of a user, and a plurality of patches and related patch-based classifications of the image in accordance with various embodiments disclosed herein.

FIG. 5B illustrates a sequence of images depicting respective boundaries defined between a skin area and a hair area of a user, wherein each image pertains to a plurality of patches and related patch-based classifications in accordance with various embodiments disclosed herein.

FIG. 6 is an image that depicts an example of a patch of the image that is pixelated.

FIGS. 7A through 7D each illustrate a plurality of patches within an image, a pixelated image of hair edges within each patch and a value of number of hair edge pixels within each patch in accordance with various embodiments disclosed herein.

FIG. 8A illustrates a flowchart that depicts one or more steps of a method for operating the smart personal grooming device in accordance with various embodiments disclosed herein.

FIG. 8B illustrates a flowchart that depicts one or more steps of a method for operating the smart personal grooming device in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

For purposes of this description, “hair area” means the area of an image that encompasses hair, particularly hair having a length greater than a length threshold (e.g. between about 0.3 mm and about 3.5 mm).

For purposes of this description, “skin area” means the area of an image that encompasses skin, including skin having hair with a length less than a length threshold (e.g. between about 0.3 mm and about 3.5 mm).

For purposes of this description, “boundary” means a region of the image defined between the hair area and the skin area.

For purposes of this description, “hair edge” means that region of a hair that defines an outer surface of the hair, particularly along the length of the hair.

For purpose of this description, “transition” means a region of the image defined between the hair edge and the skin area.

For purposes of this description, “hair edge pixels” means those pixels in an image that encompass the hair edge along the transition.

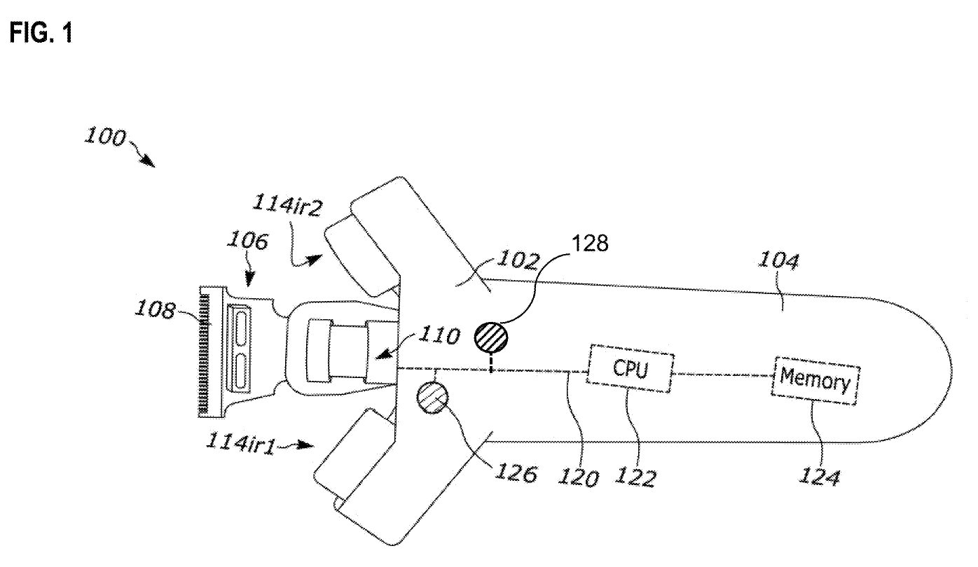

FIG. 1 illustrates an example of a smart personal grooming device 100 (e.g., an example AutoEdger device) in accordance with various embodiments disclosed herein. In the example of FIG. 1, smart personal grooming device 100 comprises a body 102 that includes a handle 104. The smart personal grooming device 100 further comprises a head portion 106 connected to body 102 and a hair cutting implement 108. In various implementations, the hair cutting implement may comprise a rotary shaver, a foil with an undercutter and/or a reciprocating blade. More generally, hair cutting implement 108 may comprise a trimmer, a cutter, or otherwise a blade-based device for cutting hair. In some implementations, haircutting implement 108 may be coupled to a motor (e.g., electric motor) for driving or otherwise actuating the haircutting implement 108, e.g., actuating a trimmer. In some implementations, the hair cutting implement can be removably connected. In various aspects, the hair cutting implement 108 may be detachable, and may comprise a cartridge or other detachable component, for coupling, decoupling, and/or otherwise attaching to head portion 106.

With further reference to FIG. 1, smart personal grooming device 100 further comprise a camera 110 oriented toward the hair cutting implement 108. In some implementations, smart personal grooming device 100 may optionally include one or more infrared light source(s). In the example implementation of FIG. 1, smart personal grooming device 100 includes an infrared light source 114ir1 and a second infrared light source 114ir2, each oriented toward the hair cutting implement 108. In one example, the camera 110 may have a frame rate of at least 30 frames per second (FPS). In another example, the camera 110 may have a frame rate of between about 10 FPS and about 500 FPS.

Smart personal grooming device 100 further comprises a processor 122 (e.g., a central processing unit (CPU)) communicatively coupled to the camera 110, through a computing bus 120, which may comprise an electrical or electronic circuit or connection. In some implementations, images or otherwise data, as captured by camera 110, may be provided to a separate or otherwise remote computing device, such as a mobile device or a remote server. Such images or data may be transmitted, for example, by a wireless or wired connection from a transceiver of the smart personal grooming device 100 to a wireless (e.g., WIFI or BLUETOOTH) access point, which may be a receiver of a mobile device (e.g., a mobile device implementing a mobile operating system, such as iOS or ANDROID) and/or a WIFI router connected to a computer network (e.g., the Internet).

In some implementations, first infrared light source 114ir1 and/or second infrared light source 114ir2 may be communicatively coupled to processor 122 via computing bus 120. The infrared light source(s) (e.g., infrared light source 114ir1 and/or second infrared light source 114ir2) may be mounted next to, around, or in a proximity to camera 110 for uniform illumination in the region of interest on the surface observed (e.g., skin area 132 and/or hair area 134) by camera 110. In various aspects, a given light source may be switched on when the smart personal grooming device 100 is switched on or otherwise provided power. By utilizing camera 110 with the infrared light source(s) (e.g., infrared light source 114ir1 and/or second infrared light source 114ir2), camera 110 can capture image(s) in ambient lighting conditions with wavelengths sufficient for detecting regions of interest (e.g., skin area 132 and/or hair area 134). In some aspects, such wavelengths may correspond to visible spectrum between 400nm and 700 nm. In some aspects, camera 110 may be configured to have no infrared filter, and thus may have an increased sensitivity to infrared spectrum, being able to detect wavelengths of light of less 800 nm. Still further, in some aspects, to enable the capture of clear images in low lighting conditions (e.g., a dark environment), infrared light source(s) (e.g., infrared light source 114ir1 and/or second infrared light source 114ir2) may be configured to output a wavelength ranging between 800 nm and 980 nm, so that camera 110 can capture image(s) for the detection of regions of interest (e.g., skin area 132 and/or hair area 134) in low lighting conditions.

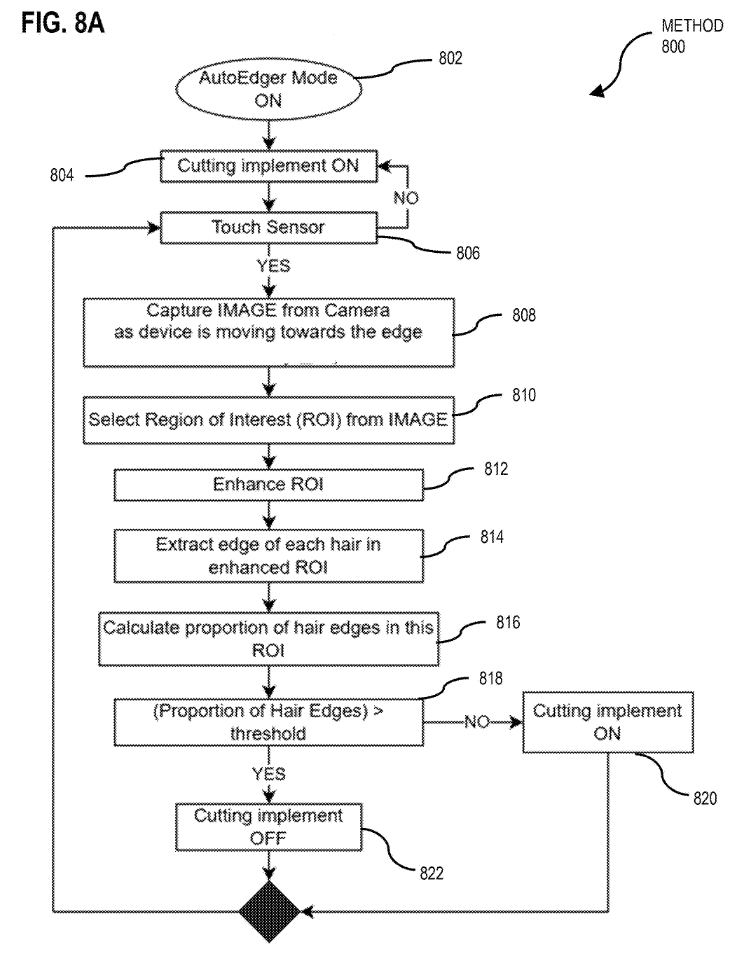

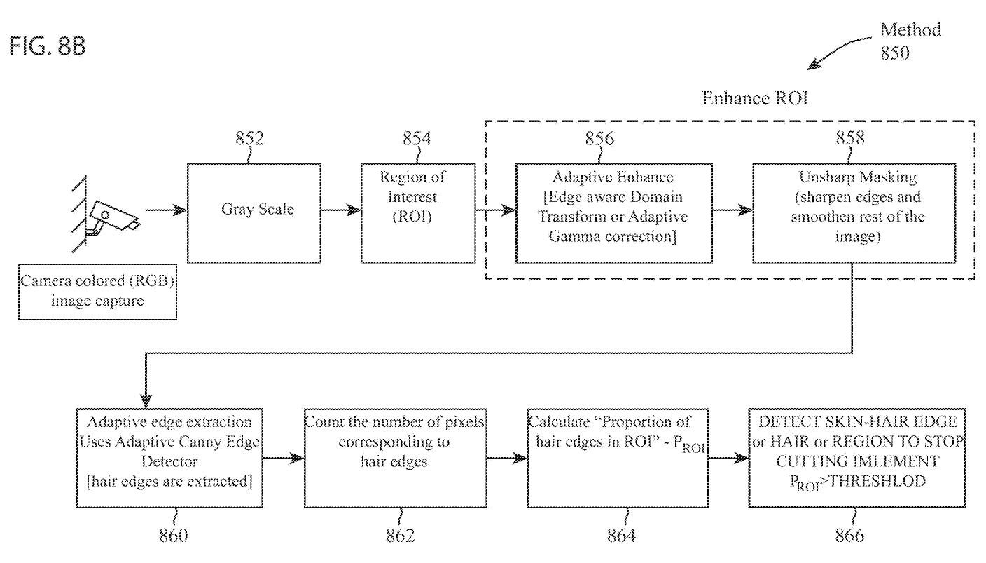

In some aspects, smart personal grooming device 100 further comprises a light emitting diode (LED) 126 for indicating detection of an edge or boundary for purposes of determining a control state, for example, as described herein. Smart personal grooming device 100 further comprises a memory 124 communicatively via the computing bus 120 coupled to the processor and storing computing instructions that, when executed by the processor 122, causes the processor 122 to implement one or more algorithms or methods, e.g., for example including those as described herein. The computing instructions may comprise instructions compiled from or otherwise interpreted from one or more programming languages including, by way of non-limiting example, Java, C, C++, C#, Python, or the like. The computing instructions, when executed by processor 122, implement algorithms or otherwise methods, which may include, for example, capturing images with camera 110 and/or controlling the cutting implement of the smart personal grooming device 100 or otherwise modifying, updating, or changing a control state or other feature (e.g., vibration) of the smart personal grooming device 100, for example, as described herein with respect to the method 800 of FIG. 8A, the method 850 of FIG. 8B or otherwise herein.

As depicted in FIG. 1, in some aspects the smart personal grooming device 100 may include a contact sensor 128. In one example, the contact sensor 128 may be a capacitive touch sensor that provides one or more capacitance values. In another example, the contact sensor 128 may be a resistance sensor that provides one or more resistance values. The contact sensor 128 may be communicatively coupled via. the computing bus 120 with the processor 122 and may be configured to transmit contact sensor data to the processor 122. Although FIG. 1 depicts that the contact sensor 128 may be positioned within the handle 104, this is merely for ease of illustration and the contact sensor 128 may be positioned so to contact a surface over which the smart personal grooming device 100 contacts and moves across. In one example, the contact sensor 128 is positioned proximate to the hair cutting implement 108 such that the contact sensor 128 contacts a same surface that is in contact with the hair cutting implement 108. Thus, in one example, the contact sensor 128 may contact the skin area 132 when the hair cutting implement 108 contacts the skin area 132 and the contact sensor 128 may contact the hair area 134 when the hair cutting implement contacts the hair area 134. In this example embodiment, the contact sensor 128 may be advantageously utilized to activate the smart personal grooming device 100 and the hair cutting implement 108 upon the contact sensor 128 making contact the skin area 132. This may advantageously save energy by only activating the hair cutting implement 108 when the contact sensor 128 is in contact with the skin area 132. This contact sensor 128 may also advantageously ensure that the camera 110 is spaced apart from the skin area 132 by a distance that is approximately the focal length of the camera 110, since the contact sensor 128 may be calibrated so to be positioned on the device 100 so that upon contacting a surface (e.g., skin area 132), the surface is at the focal length of the camera 110. In one example the contact sensor 128 has one or more dimensions, such as a length that is less than about 4 cm and a width that is less than about 4 cm.

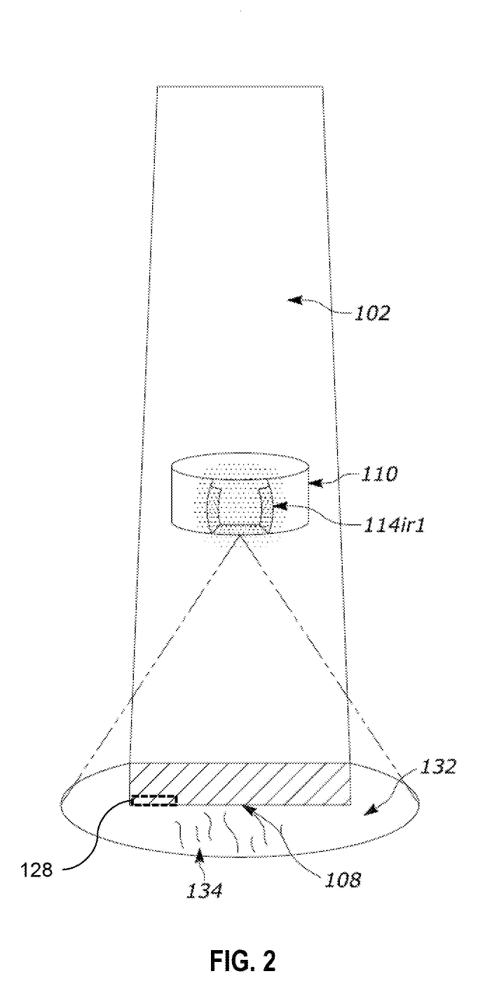

FIG. 2 illustrates an example front view of the smart personal grooming device 100 of FIG. 1 as positioned with respect to a skin area 132 and a hair area 134 of a user in accordance with various embodiments disclosed herein. In particular, as shown for FIG. 2, camera 110 may be attached to body 102 of smart personal grooming device 100. In various implementation, camera 110 may be switched on, or otherwise powered by a power source (e.g., battery, wired power source, or otherwise electrical connection) when the device is switched on or activated.

In various implementations, camera 110 may comprise an optical sensor capable of imaging a given area (e.g., a skin or hair area) of a user. Camera 110 may have an image resolution to capture images of a certain pixel density of the skin area 132 and a hair area 134 of the user near, at, or otherwise proximal to the location of the hair cutting implement 108. In one non-limiting example, camera 110 may comprise a low-resolution camera for capturing images at least 32 pixels wide by 32 pixels high.

In addition, camera 110 may be positioned in a proximity to an infrared light source, e.g., infrared light source 114ir1. For example, camera 110 may be mounted in a position to capture images illuminated by an infrared light source, e.g., infrared light source 114ir1. The camera 110 may be mounted without any infrared filter. As a result, it can capture images in the near-infrared (IR) spectrum. As shown for FIG. 2, infrared light source 114ir1 is oriented toward hair cutting implement 108 and is configured to illuminate skin area 132 and hair area 134 of a user when operating the smart personal grooming device 100. While not shown in FIG. 2, a second infrared light source (e.g., infrared light source 114ir2) can also be oriented toward the hair cutting implement 108 and may also be configured to illuminate skin area 132 and hair area 134 of the user when operating the smart personal grooming device. Use of infrared light source(s) is one way to determine whether the device is touching the user’s skin surface, skin area, or hair area.

It should be understood, however, that additional or different configurations or components could be used to determine if the device is touching the skin surface, skin area, or hair area to be treated. By way of non-limiting example, this can include time-of-flight (ToF) sensor(s) to determine skin surface, skin area, or hair area by detecting ToF data as transmitted and received by camera 110. Additionally, or alternatively, this can include a contact sensor 128 as depicted in FIG. 2 that is configured to detect the skin area 132. In one example, the contact sensor 128 may be a capacitive touch sensor positioned on the end of the smart personal grooming device 100 that can detect the skin surface, skin area, or hair area through electrical capacitance. Still further, additionally, or alternatively, this can also include detecting, by processor 122, the movement of a wheel encoder positioned on the end of the smart personal grooming device 100 that can detect the skin surface, skin area, or hair area when actuated (rolled) on the surface. In an example embodiment, the width of the contact sensor 128 (as shown in FIG. 2) may be at least 10% of the width of the hair cutting implement 108.

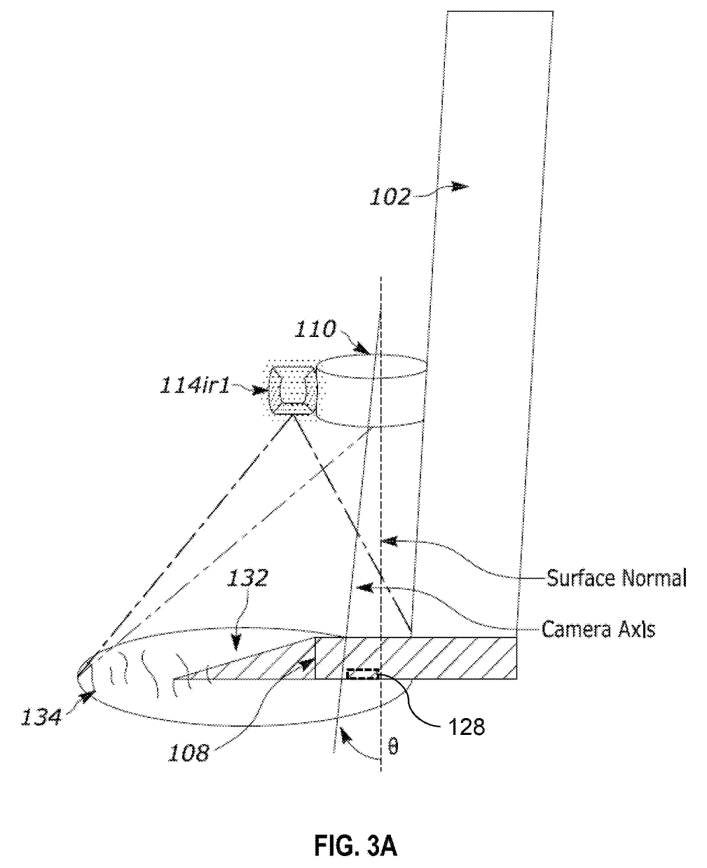

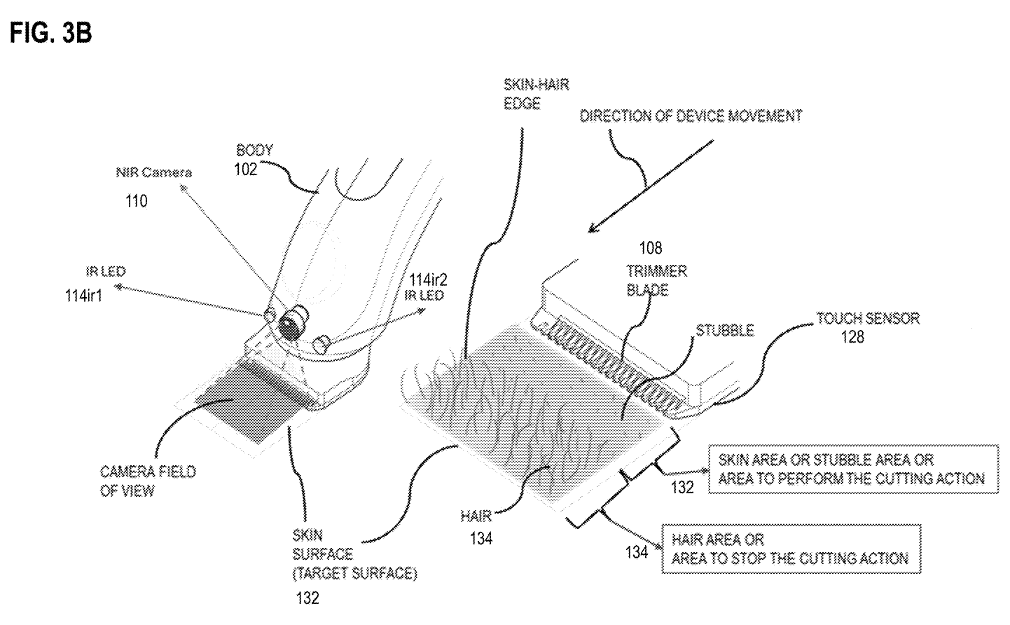

In an example embodiment, the camera 110 may be spaced a vertical distance of between about 2 cm and about 5 cm from a bottom surface of the contact sensor 128 when the smart personal grooming device 100 is on a flat horizontal surface (as shown in FIGS. 2, 3A and 3B). In this example embodiment, the camera 110 field-of-view may envelope the hair cutting implement 108 (e.g. the hair cutting implement 108 should fit within the width of the captured image). In this example, a focal length of the camera 110 may be adjusted to enable this feature.

In still another example embodiment, the contact sensor has a minimum height of about 1 mm and a minimum width of about 1 mm.

More generally, camera 110 is configured to capture image(s) depicting the skin area 132 of the user and the hair area 134 of the user. Processor 122 may then detect, based on pixel data within the images, each of the skin area 132 and/or the hair area 134. A boundary may be defined between the skin area 132 and the hair area 134, where the boundary may comprise an edge between the skin and hair, e.g., a linear area with skin having stubble and an area with a higher hair forming a beard of the user. The boundary or otherwise edge can be, at least initially, created, for example, by a barber or user using a razor, trimmer, or other device with a cutting implement.

Each of the skin area 132 and the hair area 134 defining the boundary may be detected based on pixel data within the images captured by camera 110. Each of these images may comprise pixel data (e.g., RGB data) representing feature data corresponding to skin and/or hair, within the respective image. Generally, as described herein, pixel data comprises individual points or squares of data within an image, where each point or square represents a single pixel within an image. Each pixel may be a specific location within an image. In addition, each pixel may have a specific color (or lack thereof). Pixel color may be determined by a color format and related channel data associated with a given pixel. For example, a popular color format includes the red-green-blue (RGB) format having red, green, and blue channels. That is, in the RGB format, data of a pixel is represented by three numerical RGB components (Red, Green, Blue), that may be referred to as a channel data, to manipulate the color of pixel’s area within the image. In some implementations, the three RGB components may be represented as three 8-bit numbers for each pixel. Three 8-bit bytes (one byte for each of RGB) is used to generate 24-bit color. Each 8-bit RGB component can have 256 possible values, ranging from 0 to 255 (i.e., in the base 2 binary system, an 8-bit byte can contain one of 256 numeric values ranging from 0 to 255). This channel data (R, G, and B) can be assigned a value from 0255 and be used to set the pixel’s color. For example, three values like (250, 165, 0), meaning (Red=250, Green=165, Blue=0), can denote one Orange pixel. As a further example, (Red=255, Green=255, Blue=0) means Red and Green, each fully saturated (255 is as bright as 8 bits can be), with no Blue (zero), with the resulting color being Yellow. As a still further example, the color black has an RGB value of (Red=0, Green=0, Blue=0) and white has an RGB value of (Red=255, Green=255, Blue=255). Gray has the property of having equal or similar RGB values. So (Red=220, Green=220, Blue=220) is a light gray (near white), and (Red=40, Green=40, Blue=40) is a dark gray (near black).

In this way, the composite of three RGB values creates the final color for a given pixel. With a 24-bit RGB color image using 3 bytes there can be 256 shades of red, and 256 shades of green, and 256 shades of blue. This provides 256x256x256, i.e., 16.7 million possible combinations or colors for 24-bit RGB color images. In this way, the pixel’s RGB data value shows how much of each of Red, and Green, and Blue pixel is comprised of. The three colors and intensity levels are combined at that image pixel, i.e., at that pixel location on a display screen, to illuminate a display screen at that location with that color. In is to be understood, however, that other bit sizes, having fewer or more bits, e.g., 10-bits, may be used to result in fewer or more overall colors and ranges.

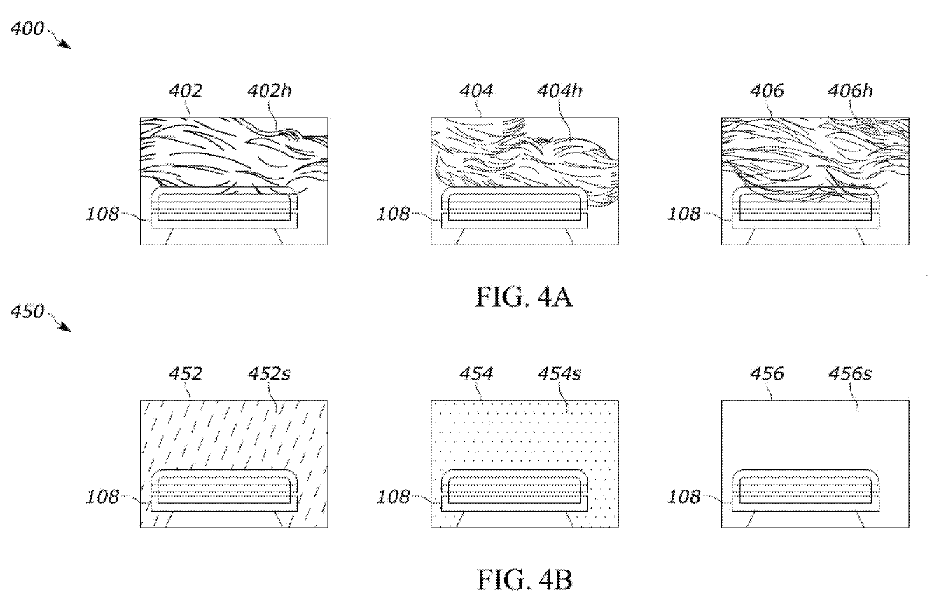

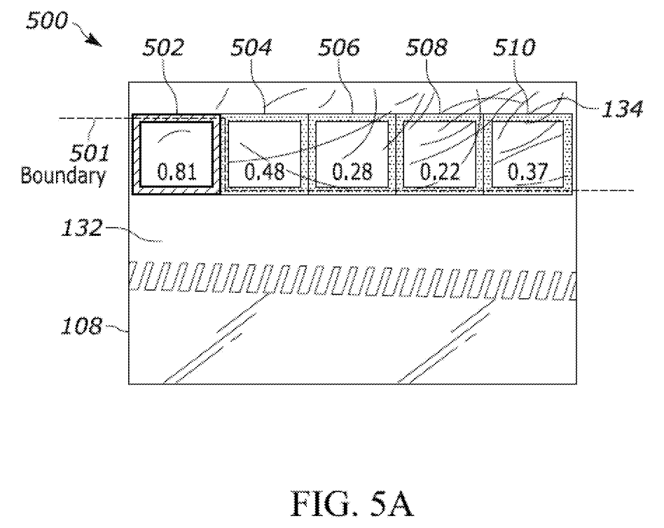

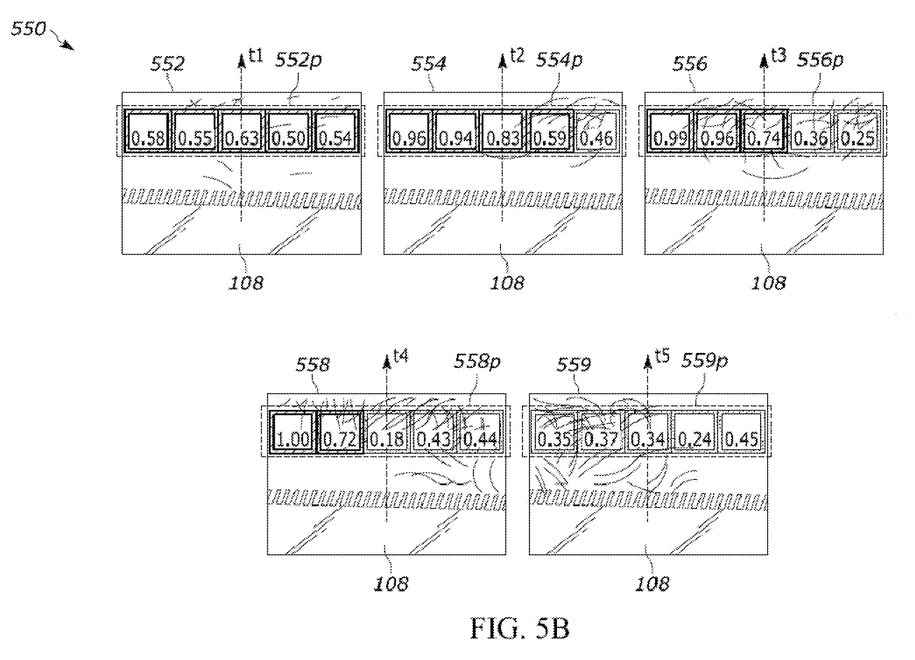

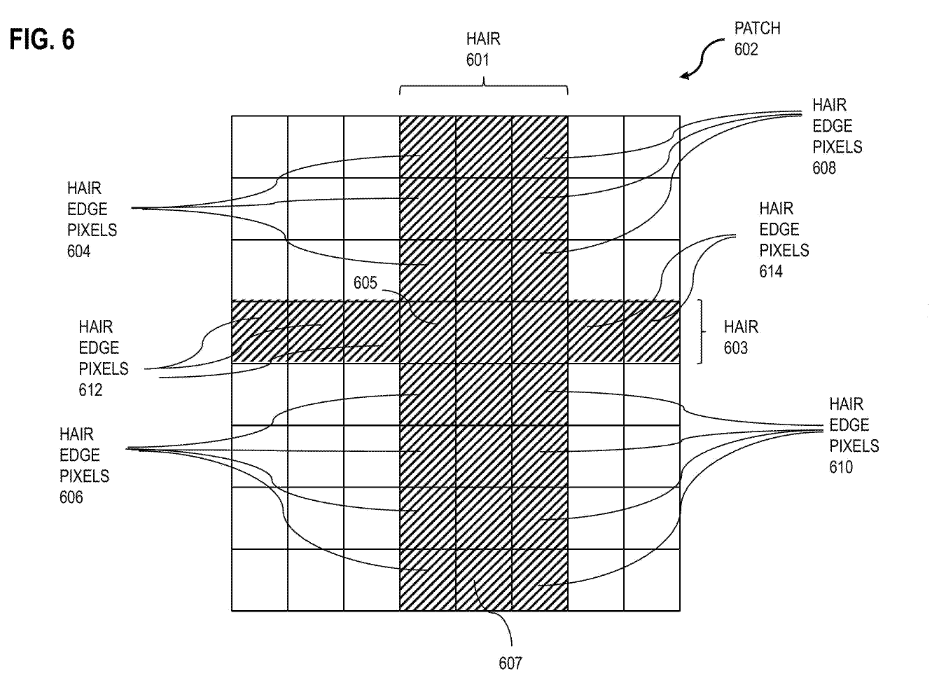

As a whole, the various pixels, positioned together in a grid pattern, form a digital image (e.g., any of the images as described herein, e.g., for FIGS. 4A, 4B, 5A, and/or 5B). A single digital image can comprise thousands or millions of pixels. Images can be captured, generated, stored, and/or transmitted in a number of formats, such as JPEG, TIFF, PNG and GIF. These formats use pixels to store represent the image.

In various aspects, processor 122 is configured to determine control state of the smart personal grooming device 100 based on the boundary as detected in the one or more images.

FIG. 3A illustrates an example side view of the smart personal grooming device 100 of FIG. 1 as positioned with respect to skin area 132 and hair area 134 of a user in accordance with various embodiments disclosed herein. FIG. 3A shows the orientation of camera 110 and infrared light source 114ir1 with respect to body 102 and hair cutting implement 108. Generally, camera 110 is oriented toward hair cutting implement 108 and configured to capture images of skin area 132 and hair area 134 of the user when the user operates the smart personal grooming device 100. The camera 110 is configured to capture one or more images, e.g., a video or a series of frames or images, while the user operates the smart personal grooming device 100. Analysis of the images enables processor 122 to control or otherwise change operation or features of the smart personal grooming device 100 based on interpretation of the optical sensor feedback signal (e.g., analysis of the pixel data). FIG. 3B depicts a similar view of the smart personal grooming device 100 positioned with respect to the skin area 132 and the hair area 134.

In some implementations, camera 110, or its lens, may be configured to have a constant focal length, or otherwise camera distance, relative to the skin area 132, hair area 134, and/or hair cutting implement 108. In a zoomed-in implementation, such focal length or otherwise camera distance may comprise a 2 millimeters (mm) to 5 mm distance from a lens of camera 110 to the skin area 132, hair area 134, and/or hair cutting implement 108. In another implementation, having a larger field of view for longer distances, such focal length or otherwise camera distance may comprise a 5 mm or greater distance from a lens of camera 110 to the skin area 132, hair area 134, and/or hair cutting implement 108. In some embodiments, the contact sensor 128 may be used to activate the camera 110 to commence capture of images from the skin area 132 and hair area 134. In this example, upon the contact sensor 128 detecting contact with the skin area 132 or hair area 134, the contact sensor 128 may transmit contact sensor data to the processor 122 indicating contact with the skin area 132 or hair area 134. The processor 122 may then transmit a signal to the camera 110 to commence capture of images of the skin area 132 and hair area 134, upon receiving this contact sensor data. This example embodiment may advantageously ensure that the camera 110 is only activated to capture images when the camera 110 is spaced from the skin area 132 or hair area 134 by a distance that is approximately equal to the focal length of the camera 110. In this example embodiment, the contact sensor 128 is calibrated such that upon detecting contact with the skin area 132, the skin area 132 is spaced apart from the camera 110 by a distance that is approximately equal to the focal length of the camera 110. This example embodiment also may advantageously save energy since it may ensure that the camera 110 (or the device 100) is only activated when the hair cutting implement 108 is in contact with the skin area 132 such that the skin area 132 is at the focal length of the camera 110.

Additionally, or alternatively, a camera orientation of camera 110 may be offset. For example, as shown for FIG. 3A, camera 110 may have an offset of +/-30 degrees relative to a surface angel of hair cutting implement 108. More generally, the angle between a camera axis of camera 110 and the surface normal can vary between 0 and 60 degrees. Offsetting, angling, or otherwise positioning the camera relative to skin area 132, hair area 134, and/or hair cutting implement 108 enables capturing of clear images for processing by processor 122. The capture of such clear images reduces noise in such images, which allows for precise and enhanced image analysis and thus control of the smart personal grooming device 100 due to less error prone image analysis.

FIG. 4A illustrates example images 400 (e.g., images 402, 404, and 406) of respective hair areas (e.g., 402h, 404h, and 406h) of a user in accordance with various embodiments disclosed herein. As shown for FIG. 4A, each of images 402, 404, and 406 depicts hair cutting implement 108 (e.g., a trimmer) engaged in trimming hair, or otherwise positioned next to hair, in respective hair areas 402h, 404h, and 406h. Each of the images 402, 404, and 406 comprise pixel data, which may be analyzed for detecting or otherwise identifying hair areas (e.g., 402h, 404h, and 406h) or elsewhere herein.

FIG. 4B illustrates example images 450 (e.g., images 452, 454, and 456) of respective skin areas (e.g., skin areas 452s, 454s, and 456s) of a user in accordance with various embodiments disclosed herein. As shown for FIG. 4B, each of images 452, 454, and 456 depicts hair cutting implement 108 (e.g., a trimmer) next to the user’s skin in respective skin areas 452s, 454s, and 456s. Each of the images 452, 454, and 456 comprise pixel data, which may be analyzed for detecting or otherwise identifying skin areas (e.g., 452h, 454h, and 456h).

FIG. 5A illustrates an image 500 depicting an edge or a boundary 501 defined between a skin area 132 and a hair area 134 of a user. FIG. 5A further depicts a plurality of regions of interest (ROIs) or patches (e.g., patches 502, 504, 506, 508, and 510) and related patch-based classifications (e.g., patch-based classifications having values of 0.81, 0.48, 0.28, 0.22, and 0.37, respectively) of image 500 in accordance with various embodiments disclosed herein. As shown for FIG. 5A, hair cutting implement 108 is positioned on the user’s skin area 132. Opposite of the hair cutting implement 108, image 500 depicts the user’s hair area 134. Image 500 also depicts several patches (e.g., patches 502, 504, 506, 508, and 510) each having an assigned or otherwise detected classification and related classification value. The patches may each comprise a certain pixel height and width (e.g., 32 pixels by 32 pixels) within image 500. In some implementations, each patch may comprise a length and/or width corresponding to (such as equal to, or slightly larger than) a length and/or width the hair cutting implement (e.g., a trimmer blade) or portion thereof, as shown for FIG. 5A. For example, in some implementations, each patch may comprise an image region having a width of 160 pixels and a height of 32 pixels (e.g., which could cover an area or portion of hair cutting implement 108). Still further, in some implementations, the patches may be superimposed on an image (e.g., image 500). In other implementations, the patches may not be superimposed, but instead determined by processor 122.

With further reference to FIG. 5A, patch 502 comprises a pixel area that has an assigned or detected classification, e.g., a region to cut classification (Region to Cut). The classification may be based on patch 502’s related classification value of 0.81, which may indicate a probability (e.g., an 81% chance) that pixels detected within patch 502 of image 500 have been detected as below a given hair classification value. That is, the patch-based classification value of 0.81 indicates that patch 502 has hair, as detected within the pixels of patch 502, as being below a given hair length threshold as set for the smart personal grooming device 100, e.g., to control smart personal grooming device 100 to cut or trim hair stubble of the user.

Similarly, each of patches 504, 506, 508, and 510 comprises a pixel area that has an assigned or detected classification, e.g., a region to stop classification (Region to Stop). The classification may be based on each of the patch’s related classification values (e.g., 0.48, 0.28, 0.22, and 0.37, respectively), which may indicate respective probabilities (e.g., 48% chance, 28% chance, 22% chance, and 37% chance, respectively) that pixels detected within the related patches (504, 506, 508, and 510, respectively) of image 500 have been detected as below a given hair classification value. That is, the patch-based classification values (e.g., 0.48, 0.28, 0.22, and 0.37, respectively) indicates that the related patches (504, 506, 508, and 510, respectively) has hair, as detected within the respective pixels, as being below a given hair length threshold value as set for the smart personal grooming device 100. Because the probabilities are low, then each of the patch-based classifications for patches 504, 506, 508, and 510 are determined as a region to stop classification (Region to Stop), e.g., to control smart personal grooming device 100 to not cut the longer hair (e.g., a bear) of the user.

While the probabilities in the above example suggest that higher probabilities (e.g., above 50%) indicate a region to cut classification, and that lower probabilities (e.g., below 50%) indicate a region to stop classification, it should be understood that different probabilities may be used. For example, the probability thresholds for determination or detection of region to stop or region to cut could be changed to any value on a percentage scale, where, for example, a higher percentage (or lower percentage as the case may be) may cause one classification or the other to be assigned or detected more frequently (or not). Still further, the probabilities may be reversed, where a higher probably (e.g., above 50%) suggests that a region to cut classification is assigned or detected, and vice versa with respect to a lower probability.

With further reference to FIG. 5A, a plurality of patches (e.g., patches 502, 504, 506, 508, and 510) may define a boundary, e.g., boundary 501. The boundary may be classified or detected as an edge between skin area 132 and hair area 134. The detection of the boundary may cause the edge of a given patch, or otherwise portion of a given patch, to be assigned or detected as an edge region classification (an Edge Region). The edge region classification (i.e., Edge Region) may define an edge of a beard or other hairstyle, such as a line or shaping of a user’s hair.

In various implementations, processor 122 may determine, detect, or create patches with respect to a given image as capture by camera 110. For example, computing instructions (e.g., as stored on memory 124 of smart personal grooming device 100) are configured, when executed, to cause the processor 122 to subdivide into a plurality of regions of interest or patches (e.g., patches 502, 504, 506, 508, and 510) an image (e.g., image 500) depicting the skin area (e.g., skin area 132) of the user and the hair area (e.g., hair area 134) of the user as captured by the camera (e.g., camera 110). Processor 122 may then assign a patch-based classification (e.g., a region to cut classification, a region to stop classification, or an edge classification) to each patch of the plurality of patches based on pixel analysis of each of the plurality of patches. The control state of smart personal grooming device 100 may then be determined, by processor 122, based on each patch-based classification.

An algorithm to determine a control of the smart personal grooming device 100 may be implemented with computing instructions (e.g., non-AI computing instructions), that may comprise if-then-else logic based on, e.g., physical parameters of hair edges, hair color, skin color, length of hair, hair style, shape of hair (e.g., curliness of hair) as identified by one or more pixel(s) of the patches. That is, a procedural (non-AI) method (if-then-else) would focus on pixel intensity of RGB values of the individual pixels as detected when the smart personal grooming device 100 moves from skin-to-hair areas or vice versa of a user. In such implementations, an image (e.g., image 500) may be subdivided into a plurality of patches (e.g., patches 502-510, where each of the one or more images depict the skin area (e.g., skin area 132) of the user and the hair area (e.g., hair area 134) of the user as captured by the camera (e.g., camera 110). Processor 122 is configured to assign a patch-based classification to each patch of the plurality of patches based on whether hair identified within a respective patch is depicted as above the hair length threshold or below the hair length threshold. The control state may then be determined or otherwise based on each patch-based classification.

FIG. 5B illustrates a sequence 550 of images (e.g., 552, 554, 556, 558, and 559) depicting respective boundaries defined between a skin area and a hair area of a user, wherein each image pertains to a plurality of patches (e.g., 552p, 554p, 556p, 558p, and 559p) and related patch-based classifications (e.g., classifications regarding cutting, stopping, or edge detected) in accordance with various embodiments disclosed herein. Sequence 550 may represent a series of images (e.g., a video of image frames) as captured by camera 110. The sequence 550 of image depicts hair cutting implement 108 of smart personal grooming device 100 (the AutoEdger) moving from a skin area (e.g., skin area 132) of the user towards a hair area (e.g., hair area 134) of the user at different points of time t₁ to t₅. That is, image 552 shows hair cutting implement 108 at t₁, image 554 shows hair cutting implement 108 at t_{2,}image 556 shows hair cutting implement 108 at t_{3,} image 558 shows hair cutting implement 108 at t_{4,} andimage 559 shows hair cutting implement 108 at t_{5.} When a boundary is detected (e.g., in image 554), the patch-based classification changes from a region to cut classification (e.g., as shown for image 554 with patches 552p having above 50% values with respect to the hair length threshold value) to a region to stop classification (e.g., as shown for image 554 with one patch below a 50% value with respect to the hair length threshold value). Later-in-time images (images 556, 558, and 559) have further patches classified, based on pixel analysis, as regions to stop classifications. Each of the remaining images (images 556, 558, and 559) have an increasing number of patches having classification values of less than 50% with respect to the hair length threshold value, thus indicating an increased number of patches with a region to stop classification as hair cutting implement 108 moves toward the hair area (e.g., a beard) of the user across time (e.g., t₂ to t₅). Thus, when a patch is classified as a region to stop classification, processor 122 signals the motor of smart personal grooming device 100 to stop, which prevents the cutting or trimming action of hair cutting implement 108.

Although the embodiments previously discussed with regard to FIGS. 5A and 5B assign a patch-based classification value to each patch that indicates a probability value that pixels within each patch has hair with a length below a hair length threshold, other patch-based classification values may be used to determine the control state classification (region to cut classification, region to stop classification, etc.). In one example, the patch-based classification may be based on a number or ratio of pixels within the patch that corresponds to one or more features of the hair or skin in the patch. In one example, the patch-based classification may be based on a number or ratio of hair edge pixels that are pixels within the patch that correspond to an edge of one or more hairs within the patch. In this example, the patch-based classification may be further based on a number or ratio of hair edge pixels within the patch that corresponds to an edge of one or more hairs and that are also adjacent to a transition between the hair edge and skin area within the patch. In one example, the patch-based classification may be based on a number or ratio of skin pixels that are pixels within the patch that correspond to the skin area within the patch.

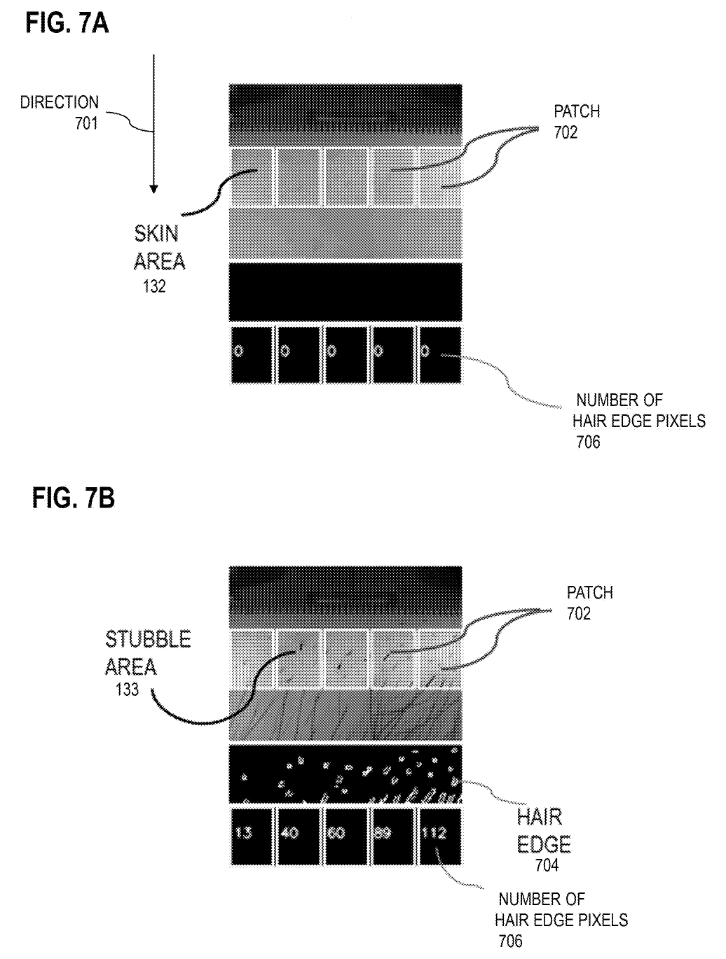

FIG. 6 depicts an example of a patch 602 with a plurality of hairs 601, 603. White pixels within the patch 602 of FIG. 6 may indicate the skin area whereas cross-hatched pixels within the patch 602 may indicate hair. As shown in FIG. 6, in this example, the pixelated patch 602 may include hair edge pixels 604, 606, 608, 610 that encompass an edge of the hair 601 and that also adjoin a transition between the skin area and hair edges within the patch 602. Pixel 605 that encompasses the edge of the hair 601 may not be counted as a hair edge pixel, since pixel 605 does not adjoin the transition between the skin area and hair edges. Additionally, pixel 607 that corresponds with an interior pixel of the hair 601 and does not correspond to the edge of hair 601 and thus may not be counted as a hair edge pixel. Additionally, as shown in FIG. 6, the hair edge pixels 612, 614 that encompass an edge of hair 604 and that also adjoin a transition between the skin hair and hair edges may be counted as hair edge pixels. In this example, the total number of hair edge pixels are counted for each patch. If this total number of hair edge pixels in the patch 602 exceeds a threshold pixel value, the patch 602 may be classified as a region to stop classification. Similarly, if the total number of hair edge pixels in the patch 602 does not exceed the threshold pixel value, the patch 602 may be classified as a region to cut classification.

In another embodiment, a total number of skin pixels may be counted and compared with a threshold pixel value. For example, in FIG. 6 the total number of skin pixels (e.g. 35) may be counted that correspond with the skin area 132. This total number may be compared with a threshold pixel value, and if the total number of skin pixels exceeds the threshold pixel value, the patch may be assigned a region to cut classification. If the total number of skin pixels is less than the threshold pixel value, the patch may be assigned a region to stop classification.

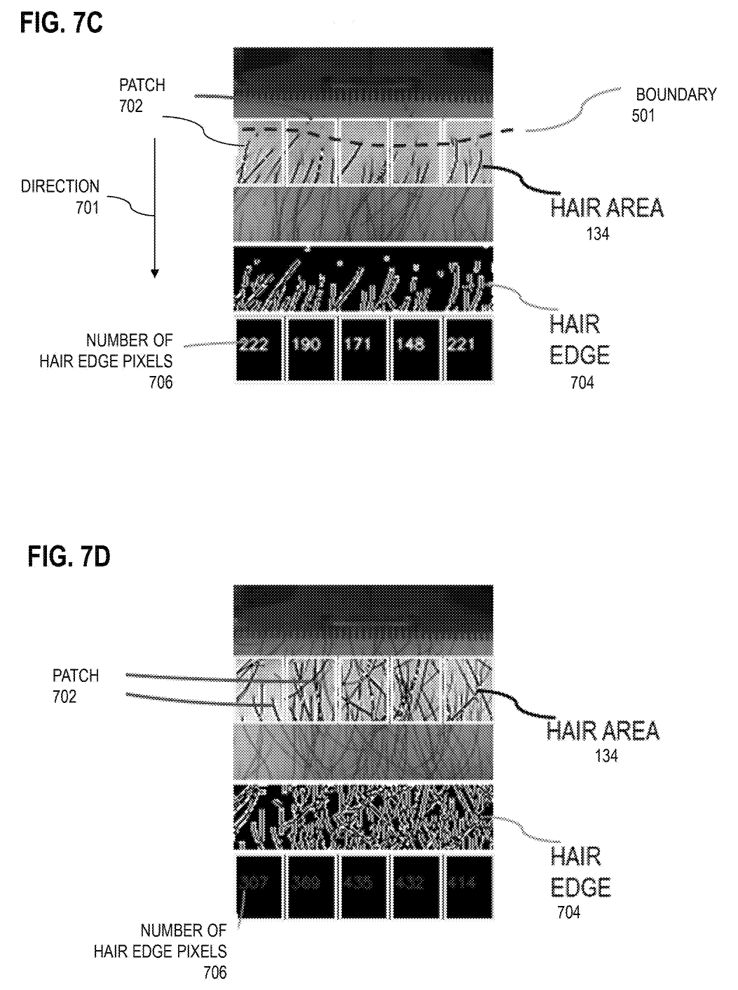

Some examples of the number of hair edge pixels being used as the patch-based classification will now be discussed. FIGS. 7A through 7D each illustrate a plurality of patches 702 within an image, a pixelated image 704 of hair edges within each patch and a value 706 of number of hair edge pixels within each patch 702 in accordance with various embodiments disclosed herein.

The images of FIGS. 7A and 7B may depict patches 702 of images captured at spaced apart time intervals as the smart personal grooming device 100 moves in direction 701 over a surface of a user. As shown in FIG. 7A, each patch 702 of the image features skin area 132. The processor 122 may be configured to pixelate each patch 702 of the image and count a number of hair edge pixels within each patch 702 of the image. As shown in FIG. 7A, a number 706 of hair edge pixels is displayed for each patch 702 (e.g. 0). This may indicate that no pixels in any of the patches 702 of the image encompass hair edges that adjoin a transition between hair and skin. In this example, for each patch 702, the processor 122 may compare the number of hair edge pixels in each patch 702 (0) with a threshold pixel value (e.g. 250). For the example of the threshold pixel value of 250, this may correspond to a patch size of about 32 pixels x 32 pixels (1024 pixels). Thus, in this example, the pixel threshold value may correspond to a certain ratio threshold of about 0.25. Since the number of hair edge pixels in each patch 702 is less than the threshold pixel value, the processor 122 may assign a region to cut classification to each patch 702. Consequently, the processor 122 may transmit a signal to the hair cutting implement 108 to be activated or to refrain from transiting a signal to deactivate the hair cutting implement 108, if the hair cutting implement 108 is already active.

After the smart personal grooming device 100 of FIG. 7A has moved in direction 701 over the surface of the user, the image of FIG. 7B may be captured. As shown in FIG. 7B, each patch 702 of the image may feature a stubble area 133 that may indicate hair within the skin area 132 that has a length that is less than the hair length threshold (e.g. between about 0.3 mm and about 3.5 mm). The processor 122 may be configured to pixelate each patch 702 of the image and count a number of hair edge pixels within each patch 702 of the image. Image 704 of FIG. 7B shows the pixelation of each patch 702, where hair edge pixels may be assigned a white color and all other pixels may be assigned a black color. As shown in FIG. 7B, a number 706 of hair edge pixels is displayed for each patch 702 (e.g. 13, 40, 60, 89, 112 for the five patches 702). This may indicate that the five patches 702 of FIG. 7B include 13 hair edge pixels, 40 hair edge pixels, 60 hair edge pixels, 89 hair edge pixels and 112 hair edge pixels, respectively, that encompass hair edges and adjoin a transition between hair and skin. In this example, for each patch 702, the processor 122 may compare the number of hair edge pixels in each patch 702 with a threshold pixel value (e.g. 250). Since the number of hair edge pixels in each patch 702 is less than the threshold pixel value, the processor 122 may assign a region to cut classification to each patch 702. Consequently, the processor 122 may transmit a signal to the hair cutting implement 108 to activate the hair cutting implement 108 or to refrain from transiting a signal to deactivate the hair cutting implement 108, if the hair cutting implement 108 is already active. Thus, although the number of hair edge pixels increased between FIG. 7A and 7B as the device 100 moved in direction 701 over the surface of the user, the number of hair edge pixels is still less than the threshold pixel value, since the hair within each patch 702 is stubble that has a length less than the length threshold. Consequently, the processor 122 does not assign a region to stop classification based on the patches 702 of the image and the hair cutting implement 108 remains active.

The images of FIGS. 7C and 7D may depict patches 702 of images captured at spaced apart time intervals as the smart personal grooming device 100 moves in direction 701 over a surface of a user. As shown in FIG. 7C, each patch 702 of the image features some hair area 134. The processor 122 may be configured to pixelate each patch 702 of the image and count a number of hair edge pixels within each patch 702 of the image. Image 704 of FIG. 7C shows the pixelation of each patch 702, where hair edge pixels may be assigned a white color and all other pixels may be assigned a black color. As shown in FIG. 7C, a number 706 of hair edge pixels is displayed for each patch 702 (e.g. 222, 190, 171, 148, 221). This may indicate that the five patches 702 of FIG. 7C include 222 hair edge pixels, 190 hair edge pixels, 171 hair edge pixels, 148 hair edge pixels and 221 hair edge pixels, respectively, that encompass hair edges and adjoin a transition between hair and skin. In this example, for each patch 702, the processor 122 may compare the number of hair edge pixels in each patch 702 with a threshold pixel value (e.g. 250). Since the number of hair edge pixels in each patch 702 is less than the threshold pixel value, the processor 122 may assign a region to cut classification to each patch 702. Consequently, the processor 122 may transmit a signal to the hair cutting implement 108 to activate the hair cutting implement 108 or to refrain from transiting a signal to deactivate the hair cutting implement 108, if the hair cutting implement 108 is already active. Although the boundary 501 between the hair area 134 and skin area 132 may be shown in the patches 702 of the image, the boundary 501 may not yet be proximate enough to the hair cutting implement 108 for the hair cutting implement 108 to be deactivated.

After the smart personal grooming device 100 of FIG. 7C has moved in direction 701 over the surface of the user, the image of FIG. 7D may be captured. As shown in FIG. 7D, each patch 702 of the image may feature hair area 134. The processor 122 may be configured to pixelate each patch 702 of the image and count a number of hair edge pixels within each patch 702 of the image. As shown in FIG. 7D, a number 706 of hair edge pixels is displayed for each patch 702 (e.g. 307, 369, 435, 432, 414 for the five patches 702). This may indicate that the five patches 702 of FIG. 7B include 307 hair edge pixels, 369 hair edge pixels, 435 hair edge pixels, 432 hair edge pixels and 414 hair edge pixels, respectively, that encompass hair edges and adjoin a transition between hair and skin. In this example, for each patch 702, the processor 122 may compare the number of hair edge pixels in each patch 702 with a threshold pixel value (e.g. 250). Since the number of hair edge pixels in each patch 702 is greater than the threshold pixel value, the processor 122 may assign a region to stop classification to each patch 702. Consequently, the processor 122 may transmit a signal to the hair cutting implement 108 to deactivate the hair cutting implement 108. Thus, as the smart personal grooming device 100 moved from FIGS. 7C to 7D, the boundary 501 between the hair area 134 and skin area 132 moved more proximate to the hair cutting implement 108. This is reflected in the increase in the number of hair edge pixels within each patch 702 in FIG. 7D exceeding the threshold pixel value.

Although the example of FIG. 7D indicated that the number of hair edge pixels in each patch 702 exceeded the threshold pixel value, in some examples if the number of hair edge pixels in even one of the patches 702 exceeds the threshold pixel value exceeds the threshold pixel value, the processor 122 may assign the region to stop classification and deactivate the hair cutting implement 108. This is done in order to avoid the hair cutting implement 108 cutting hair through the boundary 501, which may occur if the hair cutting implement 108 is not deactivated when the number of hair edge pixels in even one patch 702 exceeds the threshold pixel value.

Additionally, although the examples of FIGS. 7A through 7D employ a parameter of a total number of hair edge pixels in each patch 702 and comparison of this number with a threshold pixel value (e.g. about 250), in other embodiments a parameter of a ratio of the number of hair edge pixels to the total number of pixels in the patch may be used and compared with a threshold ratio value. In one example, the threshold ratio value may be about 0.25 or in a range from about 0.20 to about 0.30 and/or in a range from about 0.10 to about 0.50. In this example, the processor 122 may compare the ratio of hair edge pixels in the patch (e.g. 0.30) with the threshold ratio value (e.g. 0.25) and if the ratio exceeds the threshold ratio value, the processor 122 may assign a region to stop classification and deactivate the hair cutting implement 108. However, if the ratio is less than the threshold ratio value, the processor 122 may assign a region to cut classification and not deactivate the hair cutting implement 108.

Although the examples of FIGS. 7A through 7D discuss counting the total number of hair edge pixels in each patch, in other embodiments a different number of pixels may be counted. In one example, a total number of skin pixels may be counted in each patch, where each skin pixel corresponds with the skin area 132. In the example of FIG. 6, the total number of skin pixels (e.g. white pixels in FIG. 6) may be 35. The processor 122 may compare the total number of skin pixels with a threshold value and if the total number of skin pixels exceeds the threshold value, the processor 122 may assign a region to cut classification and otherwise assign a region to stop classification to the patch. In other embodiments a parameter of a ratio of the number of skin pixels to the total number of pixels in the patch may be used and compared with a threshold ratio value. In one example, the threshold ratio value may be about 0.70 or in a range from about 0.40 to about 0.90. In this example, the processor 122 may compare the ratio of skin pixels in the patch (e.g. 0.80) with the threshold ratio value (e.g. 0.70) and if the ratio exceeds the threshold ratio value, the processor 122 may assign a region to cut classification and activate the hair cutting implement 108. However, if the ratio is less than the threshold ratio value, the processor 122 may assign a region to stop classification and deactivate the hair cutting implement 108.

The processor 122 may optionally comprise an adaptive, dynamic threshold value to account for varying skin textures and localized hair densities. For example, when the device actively engages the skin (e.g., verified by an onboard touch sensor, an ongoing continuous cutting action, etc.) the processor may analyze image data from a “future ROI” positioned immediately ahead of the cutting element’s path. Importantly, the image processing pipeline used to analyze this future ROI (including image enhancement, edge extraction, and calculating the proportion of hair edges) may be identical to the process applied to the primary ROI used for the decision to activate or deactivate the cutting implement. If the proportion of edges extracted from this future ROI exceeds a minimum baseline, the system dynamically scales the detection threshold by calculating a rolling average (e.g., an exponential moving average) of the incoming future edge data. To maintain operational safety and prevent the threshold from drifting too high, the dynamic threshold may be capped at a predetermined maximum limit. Conversely, when the device is lifted from the skin or the cutting action ceases, the processor immediately resets the dynamic threshold back to a predefined default value to ensure the device is properly calibrated for the beginning of the next grooming stroke.

FIG. 8A depicts a flowchart that illustrates one or more steps of a method 800 for operating the smart personal grooming device 100. Although steps are depicted in FIG. 8A and in the subsequent flowchart of FIG. 8B as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 802, in one embodiment, the smart personal grooming device 100 may be activated. In one example embodiment, in step 802 the AutoEdger mode of the smart personal grooming device 100 may be activated.

In step 804, the hair cutting implement 108 of the smart personal grooming device 100 may be turned on. In one example, in step 804 the processor 122 may transmit a signal to the hair cutting implement 108 to turn on, based on the user turning on the AutoEdger mode in step 802. In still another example, in step 804 the processor 122 may transmit the signal to activate the hair cutting implement 108 based on the processor 122 receiving a signal from the contact sensor 128 indicating contact between the contact sensor 128 (and hair cutting implement 108) and the skin area 132 of the user. In a more specific example, in step 804 the processor may not activate the hair cutting implement 108 unless the signal is received from the contact sensor 128 indicating contact between the contact sensor 128 and the skin area 132 of the user.

In step 806, the processor 122 may determine whether the contact sensor data from the contact sensor 128 indicates contact between the contact sensor 128 (and hair cutting implement 108) and the skin area 132 of the user. If this determination is in the affirmative, the method 800 may move to block 808, otherwise the method 800 may move back to block 804.

In step 808, the camera 110 may capture one or more images of the skin area 132 and hair area 134 of the user. In one example, in step 808 the camera may capture the one or more images, as the device 100 moves along the surface of the user (e.g. skin area 132) with a certain speed and direction.

In step 810, the processor 122 may receive the image data from the camera 110 and may select one or more regions of interest or patches from the image. In one example, in step 810 the processor 122 may select the patches such that they are generally parallel to a width of the hair cutting implement 108. In one example, in step 810 the plurality of patches may each have a shape comprising one or more of a square, a rectangle, a triangle, a circle, an oval or any polygon. In one example, the plurality of patches selected in step 810 may encompass a width of the hair cutting implement 108. Although FIGS. 7A through 7D depict one row of patches within the image, in step 810 the processor may select multiple rows of patches within the image. Additionally, although FIGS. 7A through 7D depict multiple patches selected in the image, in step 810 the processor 122 may select one patch in the image or may use the entire image as the patch for purposes of the method 800 of FIG. 8A.

In step 812, each patch of the image selected in step 810 may be enhanced. In one example, this enhancement of each patch in step 812 may involve one or more of adaptive enhancement, unsharp masking and adaptive edge extraction , as discussed with respect the method of FIG. 8B.

In step 814, an edge of each hair in the enhanced patch or ROI may be extracted. In one example, in step 814 a number of hair edge pixels is determined by the processor 122 in each patch. In one example, in step 814 the number of hair edge pixels that adjoin a transition between hair and skin in each patch is counted.

In still another embodiment, in step 814 a total number of skin pixels in each patch may be counted that are a total number of pixels in each patch that correspond with the skin area 132.

In step 816, a proportion of hair edge pixels determined in step 814 to the total number of pixels in each image is calculated. For example, if a patch has 222 hair edge pixels (from step 814), in step 816 a proportion of hair edge pixels (e.g., 222) to a total number of pixels in the patch (e.g. 1024) is calculated, which is 0.217 in this example. In another embodiment, in step 816 the total number of hair edge pixels in each patch is used in the later step 818 and thus in this example the proportion is not calculated.

In still another embodiment, in step 816 a total number of skin pixels in each patch may be counted that are a total number of pixels in each patch that correspond with the skin area 132. In one example, in step 816 the proportion of skin pixels among all of the pixels in the patch may be calculated.

In step 818, the calculated proportion of hair edge pixels from step 816 is compared with a threshold proportion. For example, where the hair edge pixel ratio of 0.217 is calculated in the above example in step 816, this may be compared with a threshold proportion (e.g. 0.25). If the calculated proportion is less than the threshold proportion, the processor 122 may assign a region to cut classification to the patch and move to step 820. However, if the calculated proportion from step 816 exceeds the threshold proportion, the processor 122 may assign a region to stop classification to the patch and move to step 822. As previously discussed, in one example if any of the patches of the image feature a region to stop classification, the processor 122 may assign a region to stop classification to the image and thus may deactivate the hair cutting implement 108.

In still another embodiment, in step 818, where step 816 involved counting a total number of hair edge pixels in each patch, in step 818 the processor 122 compares the total number of hair edge pixels (e.g. 222) from the patch with a threshold pixel value (e.g. 250). If the total number of hair edge pixels exceeds the pixel threshold value, the method 800 may move to step 822. If the total number of hair edge pixels is less than the pixel threshold value, the method 800 may move to step 820.

In still another embodiment, in step 818, where step 816 involved counting a total number of skin pixels in each patch, in step 818 the processor 122 compares the total number of skin pixels (e.g. 800) from the patch with a threshold pixel value (e.g. 700). If the total number of skin pixels exceeds the pixel threshold value, the method 800 may assign a region to cut classification to the patch and move to step 820. If the total number of skin pixels is less than the pixel threshold value, the method 800 may assign a region to stop classification to the patch and move to step 820.

In step 820, the processor 122 may transmit a signal to the hair cutting implement 108 to activate the hair cutting implement or refrain from transmitting a signal the hair cutting implement 108 if the hair cutting implement 108 is already activated. As shown in FIG. 8A, after step 820 the method 800 may move back to step 806.

In step 822, the processor 122 may transmit a signal to the hair cutting implement 108 to deactivate the hair cutting implement 108. As shown in FIG. 8A, after step 822 the method 800 may move back to step 806.

FIG. 8B depicts a flowchart that illustrates one or more steps of a method 850 for operating the smart personal grooming device 100.

In step 852, upon receiving the image from the camera 110 the processor 122 may convert the image to greyscale.

In step 854, the processor 122 may perform a similar step as step 810 in FIG. 8A where the image is divided into one or more patches of regions of interest (ROI).

In steps 856 and 858, each patch or ROI of the image may be enhanced using adaptive enhance (Step 856) techniques and/or unsharp masking (step 858) techniques, as appreciated by one skilled in the art.

For example, in step 856, the processor 122 may perform the adaptive enhancement by observing the whole image and performing an estimate as to whether the image is too bright, too dark, etc. Depending on the image contrast, the processor 122 may decide on a factor to be applied to the image. This factor may depend on lighting conditions when the image was captured by the camera 110.

For example, in step 858, the processor 122 may perform the unsharp masking by smoothing out part of the image with the exception of the hair edges. This may enhance a transition between the hair edge pixels and the adjacent pixels (e.g. skin pixels).

For example, in step 860, the processor 122 may perform the adaptive edge extraction by first observing the hair that is enhanced with the enhanced edges from step 858. The processor 122 may then extract the hair edge pixels from each patch of the image. In one example, in step 860 the processor 122 may apply a gamma edge detector to extract out the hair edge pixels. The processor 122 may observe statistics of the whole image or patch within the image and count the number of hair edge pixels.

In one example steps 862 and 864 of the method 850 may be similar to steps 814 and 816 of the method 800.

In one example step 866 of the method 850 may be similar to steps 818 through 822 of the method 800.

### ADDITIONAL CONSIDERATIONS

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A smart personal grooming device comprising:
a body comprising a handle;
a head portion connected to the body and a hair cutting implement;
a camera oriented toward the hair cutting implement and configured to capture one or more images of a skin area and a hair area of a user when operating the smart personal grooming device;
a processor communicatively coupled to the camera; and
a memory communicatively coupled to the processor and storing computing instructions that, when executed by the processor, causes the processor to:
capture, by the camera, one or more images depicting the skin area of the user and the hair area of the user,
use the one or more images to pixelate hair edges;
count a value of pixels in the one or more images;
detect, based on the counted value of pixels, each of the skin area and the hair area, wherein a boundary is defined between the skin area and the hair area; and
determine a control state based on the boundary as detected in the one or more images,
wherein the control state causes the computing instructions to execute the processor to implement at least one of:
(a) activate the hair cutting implement to cause the hair cutting implement to remove hair in the hair area of the user;
(b) deactivate the hair cutting implement;
(c) activate of a haptic vibrator of the smart personal grooming device;
(d) activate an audio device of the smart personal grooming device;
(e) initiate a visual indicator of the smart personal grooming device; or
(f) changing a cutting speed of the hair cutting implement.

2. The smart personal grooming device of claim 1, wherein the memory communicatively coupled to the processor and storing computing instructions, that, when executed by the processor, further cause the processor to:
separate each of the one or more images into one or more patches;
wherein the use of the one or more images to pixelate the hair edges comprises pixelating the hair edges in each of the one or more patches; and
wherein the count of the value of hair edge pixels comprises a count of the value of hair edge pixels in each of the one or more patches.

3. The smart personal grooming device of claim 2, wherein the pixelation of the hair edges in each of the one or more patches comprises pixelating the hair edges adjacent a transition between the hair area and the skin area such that the counted value of pixels indicate a value of pixels in each of the one or more patches that encompass hair edges adjacent the transition between the hair area and the skin area.

4. The smart personal grooming device of claim 3, wherein the processor compares a value of counted pixels in each of the one or more patches with a threshold pixel value to detect the boundary defined between the skin area and the hair area.

5. The smart personal grooming device of claim 4, wherein a value of the counted pixels in each of the one or more patches below the threshold pixel value represents a skin area and a value of the counted pixels in each of the one or more patches above the threshold pixel value represents a hair area.

6. The smart personal grooming device of claim 4, wherein the value of counted pixels is a number of skin pixels, wherein the value of the counted pixels in each of the one or more patches above the threshold pixel value represents a skin area and a value of the counted pixels in each of the one or more patches below the threshold pixel value represents a hair area.

7. The smart personal grooming device of claim 5, wherein the processor detects the boundary defined between the skin area and the hair area based on the value of the counted pixels in at least one of the one or more patches being above the threshold pixel value.

8. The smart personal grooming device of any of claims claim 2, wherein the one or more patches encompass a width of the hair cutting implement.

9. The smart personal grooming device of claim 4, wherein each patch of the one or more patches has an area that encompasses a total number of pixels and wherein the threshold pixel value is a ratio of the total number of pixels, wherein the ratio is greater than about 0.10 and less than about 0.50.

10. The smart personal grooming device of claim 1, wherein the processor is configured to pixelate the hair edges in each of the one or more images based on each of the adaptive enhancement, the unsharp masking and the adaptive edge extraction being performed on each of the one or more images.

11. The smart personal grooming device of claim 2, further comprising:
subdividing into the one or more patches each of the one or more images depicting the skin area of the user and the hair area of the user as captured by the camera, and
assigning a patch-based classification to each patch of the one or more patches based on comparing a value of the counted pixels in each of the one or more patches with a threshold pixel value,
wherein the control state is based on each patch-based classification.

12. The smart personal grooming device of claim 1, comprising an infrared light source oriented toward the hair cutting implement and configured to illuminate the skin area and hair area of a user when operating the smart personal grooming device.

13. The smart personal grooming device of claim 12, further comprising a second infrared light source oriented toward the hair cutting implement and configured to illuminate the skin area and hair area of a user when operating the smart personal grooming device.

14. The smart personal grooming device of claim 1, further comprising a contact sensor associated with the cutting implement such that the contact sensor is in contact with a skin area of a user, when operating the smart personal grooming device, and wherein the contact sensor is communicatively coupled with the processor and wherein the determination of the control state is further based on contact sensor data received from the contact sensor.

15. The smart personal grooming device of claim 14, wherein the smart personal grooming device is deactivated until the contact sensor detects contact of the smart personal grooming device with the skin area or the hair area.

16. The smart personal grooming device of claim 1, wherein the camera has a frame rate between 10 to 500 FPS.

17. The smart personal grooming device of claim 4, wherein the threshold pixel value is a dynamic threshold value, and wherein the computing instructions further cause the process to dynamically adjust the dynamic threshold value during operation based on a real-time operational parameter.

18. The smart personal grooming device of claim 17, wherein the real-time operational parameter comprises a value of counted pixels within a future patch extracted from the one or more images, the future patch corresponding to a physical area positioned ahead of the hair cutting implement in a direction of device movement.

19. The smart personal grooming device of claim 18, further comprising a touch sensor configured to detect physical contact between the device and the user; wherein the processor dynamically adjusts the dynamic threshold value to a predefined default value when the physical contact is no longer detected.

20. A smart personal grooming method comprising:
capturing, by a camera, one or more images depicting a skin area of a user and a hair area of the user, wherein the camera is positioned relative to a body comprising a handle, wherein a head portion is connected to the body and a hair cutting implement, and wherein the camera is oriented toward the hair cutting implement and configured to capture images of the skin area and the hair area of the user when the user uses the hair cutting implement to cut or trim hair,
separating, with a processor communicatively coupled with the camera, each of the one or more images into one or more patches;
pixelating, with the processor, hair edges in each of the one or more patches for each of the one or more images;
counting, with the processor, a value of pixels in each of the one or more patches in each of the one or more images;
detecting, by the processor, based on the counted value of pixels, each of the skin area and the hair area, wherein a boundary is defined between the skin area and the hair area;
determining, by the processor, a control state based on the boundary as detected in the one or more images; and
implementing, by the processor based on the control state, at least one of:
(a) activating the hair cutting implement to cause the hair cutting implement to remove hair in the hair area of the user;
(b) deactivating the hair cutting implement;
(c) activating of a haptic vibrator;
(d) activating an audio device;
(e) initiating a visual indicator; or
(f) changing a cutting speed of the hair cutting implement.
